(19) United States
(12) Patent Application Publication
(10) Pub. No.: US 2020/0048035 A1
(43) Pub. Date: Feb. 13, 2020

(54) ELEVATOR PASSENGER INTERFACE INCLUDING SPECIAL ASSISTANCE FEATURES

(71) Applicant: Otis Elevator Company, Farmington, CT (US)

(72) Inventors: Putla Vasudev Dayasagar, Hyderabad (IN); Sreedhar Chinthapalli, Hyderabad (IN); Naveen Atla, Puppalaguda (IN)

(21) Appl. No.: 16/538,186

(22) Filed: Aug. 12, 2019

(30) Foreign Application Priority Data
Aug. 10, 2018 (IN) 201811030189

(51) Int. Cl. B66B 1/46; B66B 3/00; B66B 1/52

(52) U.S. Cl. CPC B66B 1/463; B66B 3/002; B66B 2201/463; B66B 2201/4623; B66B 1/52

(57) ABSTRACT

A method for making elevator service requests. The method includes determining a destination requested by a passenger responsive to a passenger touching an appropriate portion of a touch screen of a passenger interface device configured to allow a passenger to indicate a request for elevator service by touching the screen, an assistance up button and an assistance down button near the touch screen, determining that the assistance up button or the assistance down button is being pressed, and determining a destination requested by a passenger responsive to a passenger manipulating the assistance up button or the assistance down button and then subsequently manipulating the assistance up button and assistance down button.

### FOREIGN PRIORITY

This application claims priority to Indian Patent Application No. 201811030189, filed Aug. 10, 2018, and all the benefits accruing therefrom under 35 U.S.C. § 119, the contents of which in its entirety are herein incorporated by reference.

### BACKGROUND

The embodiments herein relate to an elevator passenger interface with special assistance features, more specifically special assistance controls and displays.

Elevator systems are in widespread use for carrying passengers between different levels in a building. Over the years, there have been a variety of advances and changes in elevator system components. One such advance has been in the area of passenger interfaces. Traditionally, hall call buttons allowed a passenger to request an elevator car to carry them up or down from their current location. More sophisticated devices have been introduced that allow a passenger to specify their intended destination before they board an elevator car. Such destination-entry systems present a variety of possibilities for configuring the passenger interface.

A contemporary device that is well-suited for destination-entry passenger interfaces is a touch screen that displays information to a passenger and allows a passenger to make selections to communicate their intended destination to the elevator system. One advantage to touch screen displays is that they provide an ability to customize the display to meet passenger or building owner needs, for example. One drawback to touch screen displays, however, is that they typically do not allow visually impaired or blind passengers to communicate their intended destinations to the elevator system. The nature of a touch screen display does not allow for tactical indicators that would assist a visually impaired or blind person to make an appropriate selection or to otherwise interact with the passenger interface device.

### SUMMARY

According to an embodiment, described herein is a method for making elevator service requests. The method includes determining a destination requested by a passenger responsive to a passenger touching an appropriate portion of a touch screen of a passenger interface device configured to allow a passenger to indicate a request for elevator service by touching the screen, an assistance up button and an assistance down button near the touch screen, determining that the assistance up button or the assistance down button is being pressed, and determining a destination requested by a passenger responsive to a passenger manipulating the assistance up button or the assistance down button and then subsequently manipulating the assistance up button and assistance down button.

In addition to one or more of the features described herein, or as an alternative, further embodiments may include determining if the assistance up button or the assistance down button has been pressed and released, causing an audible announcement or visual display of a plurality of possible destinations to be provided to the passenger from the device, and prompting the passenger to press the assistance up button or assistance down button a second time when the passenger hears an audible announcement or sees the visual display of the passenger's desired destination from the device, and determining the passenger's intended destination based on a timing that the assistance button is released relative to the audible announcement or visual display.

In addition to one or more of the features described herein, or as an alternative, further embodiments may include providing at least one of audible indication and visual display of possible destinations to the passenger responsive to determining that the assistance up button or the assistance down button has been pressed, and providing at least one of an audible selection and a visual display to the passenger of a plurality of possible starting destinations from which to begin the at least one of audible indications and visual display.

In addition to one or more of the features described herein, or as an alternative, further embodiments may include selecting the at least one destination based on a time of day.

In addition to one or more of the features described herein, or as an alternative, further embodiments may include prompting the passenger to hold the assistance up button or the assistance down button until the passenger hears an audible announcement or sees a visual display of the passenger's desired destination from the device, causing an audible announcement or a visual display of a plurality of possible destinations to be provided to the passenger from the device, and determining the passenger's intended destination based on a timing that the assistance up button or the assistance down button is released relative to the audible announcement or visual display.

In addition to one or more of the features described herein, or as an alternative, further embodiments may include providing at least one of audible indications and visual display of possible destinations to the passenger responsive to determining that the assistance up button or the assistance down button has been pressed and providing at least one of an audible selection and a visual display to the passenger of a plurality of possible starting destinations from which to begin the at least one of audible indications and visual display.

In addition to one or more of the features described herein, or as an alternative, further embodiments may include providing at least one of an audible indication and visual display of possible destinations to a passenger responsive to determining that the assistance up button or assistance down button has been pressed and beginning at least one of the audible indications and visual display with at least one destination that has been selected as a first option based on a popularity of the at least one destination and a time of day.

In addition to one or more of the features described herein, or as an alternative, further embodiments may include causing the device to provide an audible indication or a visual display of a possible destination responsive to each subsequent press of the assistance up button or the assistance down button, prompting the passenger to press the assistance up button or assistance down button repeatedly until the passenger hears an announcement or sees the visual display of the passenger's intended destination and to hold the assistance up button or the assistance down button in a pressed position when the intended destination is announced or displayed until the passenger hears or sees a confirmation of the intended destination, providing an audible confirmation or a visual display of a destination corresponding to the destination prior to the passenger holding the assistance up button or assistance down button in the pressed position, and determining the passenger's intended destination to be the destination of the confirmation.

In addition to one or more of the features described herein, or as an alternative, further embodiments may include providing at least one of audible indications and visual display of possible destinations to the passenger responsive to determining that the assistance up button or the assistance down button has been pressed and providing at least one of an audible selection and a visual selection to the passenger of a plurality of possible starting destinations from which to begin the at least one of audible indications and visual display.

In addition to one or more of the features described herein, or as an alternative, further embodiments may include that providing at least one of an audible indication and a visual display of possible destinations to a passenger responsive to determining that the assistance up button or assistance down button has been pressed and beginning the at least one of audible indications and visual display with at least one destination that has been selected as a first option based on a popularity of the at least one destination and a time of day.

Also described herein in an embodiment is an elevator passenger interface device. The elevator passenger interface device including a touch screen configured to allow a passenger to indicate a request for elevator service by touching the screen, an assistance up button and an assistance down button disposed near the touch screen, and a controller configured to execute a method of destination entry. The method including the controller configured to determine a destination requested by a passenger touching the screen and determine whether the assistance up button or assistance down button has been manipulated and then to determine a destination requested by a passenger from a subsequent manipulation of the assistance up button or the assistance down button.

In addition to one or more of the features described herein, or as an alternative, further embodiments may include that the controller is configured to determine that the assistance up button or assistance down button has been pressed and released, prompt the passenger to press and hold the assistance up button or assistance down button a second time until the passenger at least one of hears an audible announcement and sees a visual display of the passenger's desired destination from the device, cause at least one of an audible announcement and a visual display of a plurality of possible destinations to be provided to the passenger from the device, and determine the passenger's intended destination based on a timing that the assistance up button or assistance down button is released relative to the at least one of an audible announcement and a visual display.

In addition to one or more of the features described herein, or as an alternative, further embodiments may include that the controller is configured to determine the passenger's intended destination to correspond to the most recently announced destination or visual display prior to the when the passenger released the assistance up button or assistance down button.

In addition to one or more of the features described herein, or as an alternative, further embodiments may include that the controller is configured to provide at least one of an audible indication and a visual display of possible destinations to the passenger responsive to determining that the assistance up button or assistance down button has been pressed, and to provide at least one of an audible selection and a visual selection to the passenger of a plurality of possible starting destinations from which to begin the at least one of audible indications and visual display.

In addition to one or more of the features described herein, or as an alternative, further embodiments may include that the controller is configured to provide at least one of an audible indication and a visual display of possible destinations to a passenger responsive to determining that the assistance up button and assistance down button has been pressed, wherein the at least one of an audible indication and a visual display begin with at least one destination that has been selected as a first option based on a popularity of the at least one destination and a time of day.

In addition to one or more of the features described herein, or as an alternative, further embodiments may include the controller is configured to determine that the assistance up button or assistance down button is being pressed, prompt the passenger to hold the assistance up button or assistance down button until the passenger at least one of hears an audible announcement and sees a visual display of the passenger's desired destination from the device, cause at least one of an audible announcement and a visual display of a plurality of possible destinations to be provided to the passenger from the device, and determine the passenger's intended destination based on a timing that the assistance up button or assistance down button is released relative to the at least one of the audible announcement and the visual display.

In addition to one or more of the features described herein, or as an alternative, further embodiments may include that the controller is configured to determine the passenger's intended destination to correspond to the most recently announced destination prior to the when the passenger released the assistance up button or assistance down button.

In addition to one or more of the features described herein, or as an alternative, further embodiments may include that the controller is further configured to provide at least one of an audible indication and a visual display of possible destinations to the passenger responsive to determining that the assistance up button or assistance down button has been pressed and provide at least one of an audible selection and a visual display to the passenger of a plurality of possible starting destinations from which to begin the at least one of audible indications and visual display.

In addition to one or more of the features described herein, or as an alternative, further embodiments may include that the controller is configured to provide at least one of an audible indication and a visual display of possible destinations to a passenger responsive to determining that the assistance up button or assistance down button having been pressed, wherein at least one of the audible indications and the visual display begin with at least one destination that has been selected as a first option based on a popularity of the at least one destination and a time of day.

In addition to one or more of the features described herein, or as an alternative, further embodiments may include that the controller is configured to determine that the assistance up button or assistance down button has been pressed, cause the device to provide at least one of an audible indication and a visual display of a possible destination responsive to each subsequent press of the assistance up button or assistance down button, prompt the passenger to press the assistance up button or assistance down button repeatedly until the passenger at least one of hears an announcement and sees a visual display of the passenger's intended destination and to hold the assistance up button or assistance down button in a pressed position when the intended destination is announced or displayed until the passenger hears a confirmation of the intended destination, provide at least one of an audible confirmation and a visual display of a destination corresponding to at least one of an announced and displayed destination prior to the passenger holding the assistance up button or assistance down button in the pressed position, and determine the passenger's intended destination to be the destination of the confirmation.

In addition to one or more of the features described herein, or as an alternative, further embodiments may include that the controller is configured to provide at least one of an audible indication and a visual display of possible destinations to the passenger responsive to determining that the assistance up button or assistance down button has been pressed and provide at least one of an audible selection and a visual display to the passenger of a plurality of possible starting destinations from which to begin the at least one of an audible indication and a visual display.

In addition to one or more of the features described herein, or as an alternative, further embodiments may include that the controller is configured to provide an at least one of an audible indication and a visual display of possible destinations to a passenger responsive to determining that the assistance up button or assistance down button has been pressed, wherein the at least one of an audible indication and a visual display begin with at least one destination that has been selected as a first option based on a popularity of the at least one destination.

In addition to one or more of the features described herein, or as an alternative, further embodiments may include that the controller is configured to select the at least one destination based on a time of day.

Technical effects of embodiments of the present disclosure include destination entry system featuring a touch screen and assistance up and assistance down buttons as well as visual display. The destination entry system is configured to allow a passenger to indicate a request for elevator service by touching the screen, an assistance up button and an assistance down button near the touch screen. A controller is configured to determine that the assistance up button or the assistance down button is being pressed, and determining a destination requested by a passenger responsive to a passenger manipulating the assistance up button or the assistance down button and then subsequently manipulating the assistance up button and assistance down button. The selected destinations and individual car assignments are displayed for approaching passengers to observe.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited to the accompanying figures in which like reference numerals indicate similar elements.

FIG. 1 is a schematic illustration of an elevator system that may employ various embodiments of the present disclosure;

FIGS. 2A and 2B are schematic illustrations of an elevator system in accordance with an embodiment of the present disclosure;

FIG. 3 is a schematic illustration of a network system in accordance with an embodiment of the present disclosure;

FIG. 4 is a schematic illustration of a computing system of a user device in accordance with an embodiment of the present disclosure;

FIG. 5 is a simplified flowchart of a method of placing a destination request in accordance with an embodiment of the present disclosure.

FIG. 6 is a simplified flowchart of a method of placing a destination request in accordance with another embodiment of the present disclosure; and

FIG. 7 is a simplified flowchart of a method of placing a destination request in accordance with yet another embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

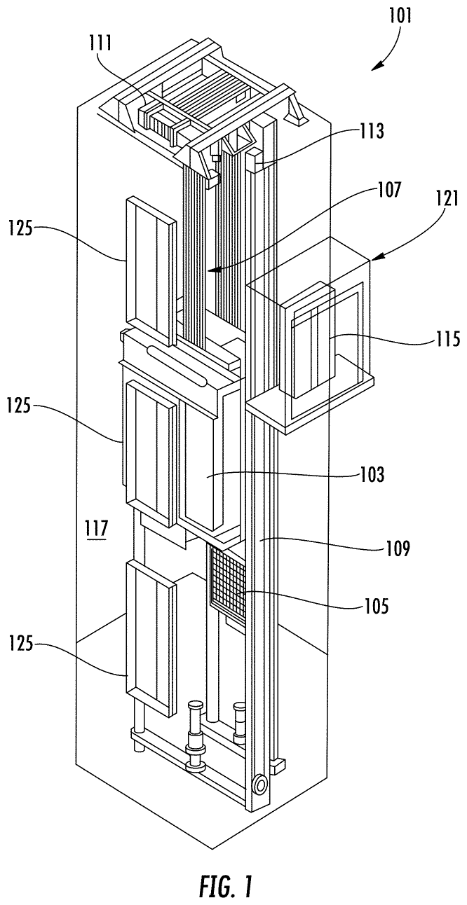

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car 103 and/or counter weight 105, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car 103 within an elevator shaft 117 may employ embodiments of the present disclosure. For example, embodiments may be employed in ropeless elevator systems using a linear motor to impart motion to an elevator car 103. Embodiments may also be employed in ropeless elevator systems using a hydraulic lift to impart motion to an elevator car 103. FIG. 1 is merely a non-limiting example presented for illustrative and explanatory purposes.

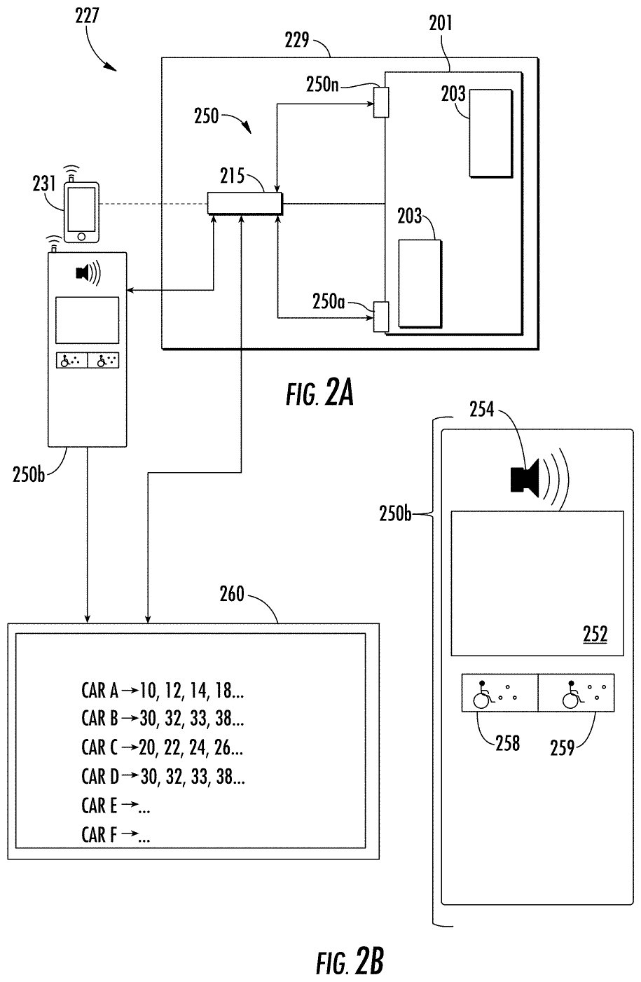

Turning now to FIGS. 2A and 2B, a schematic illustration of a building system 227 as an example embodiment of the present disclosure is shown. The building system 227 includes an elevator system 201 installed within a structure 229 (e.g., a building). In some embodiments, the structure 229 may be an office building or a collection of office buildings that may or may not be physically located near each other. The structure 229 may include any number of floors that are accessible by the elevator system 201 and thus the structure 229 can include any number of landings (e.g., as shown in FIG. 1). Persons entering the structure 229 may enter at a lobby floor and may travel to a destination floor via one or more elevator cars 203 that are part of the elevator system 201.

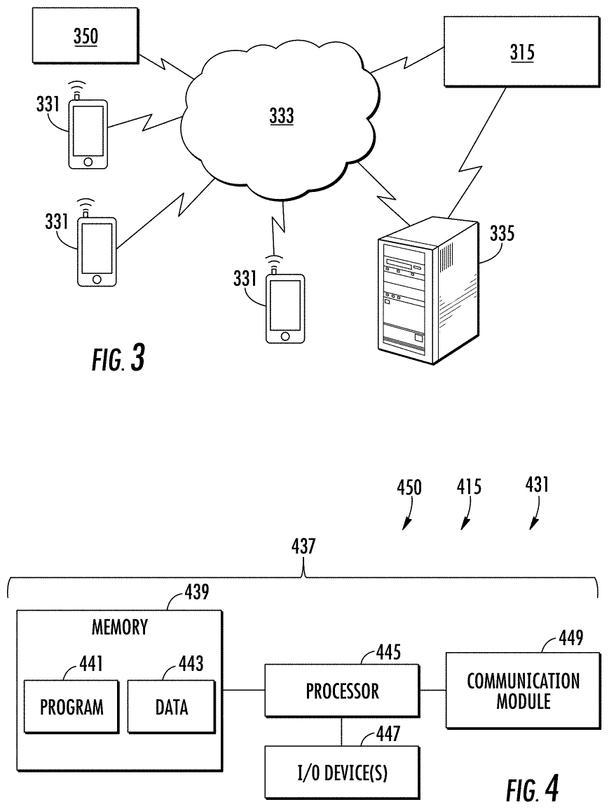

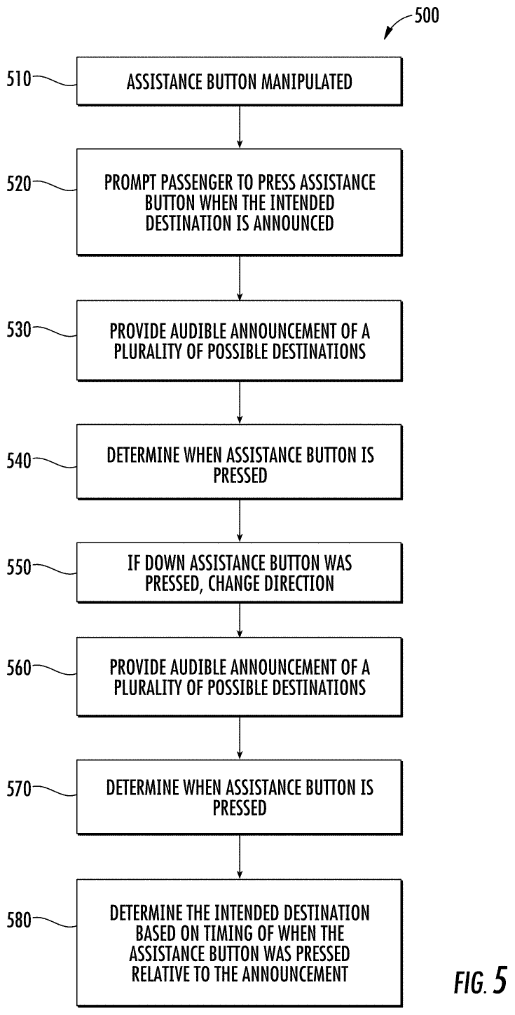

The elevator system 201 may include one or more computing devices, such as an elevator controller 215. The elevator controller 215 may be configured to control dispatching operations for one or more elevator cars 203 associated with the elevator system 201. It is understood that the elevator system 201 may utilize more than one elevator controller 215, and that each elevator controller 215 may control a group of elevators cars 203. The elevator system 201 also includes one or more fixtures shown generally as 250 and more particularly as 250a, 250b, . . . 250n each distributed at a lobby in the building and one or more floors. The fixtures 250 include, but are not limited to an elevator call button, hall call buttons e.g., 250a, and the like and may further include information panels, lanterns, direction arrows and the like as may be employed to provide information about the elevator cars 203 and their destinations. The fixtures may also include a control panel passenger interface or kiosk 250b where a passenger may enter a destination request. The fixtures 250, including passenger interface or kiosk 250b may include a processor, memory, and communication module(s), as shown in FIG. 4. As described below, the processor can be any type or combination of computer processors, such as a microprocessor, microcontroller, digital signal processor, application specific integrated circuit, programmable logic device, and/or field programmable gate array. The memory can be a non-transitory computer readable storage medium tangibly embodied in the fixture 250 including executable instructions stored therein, for instance, as firmware. The communication module may implement one or more communication protocols as described in further detail herein, and may include features to enable wireless communication with external and/or remote devices separate from the fixture 250. The fixture 250 may further include a user interface (e.g., a display screen, a microphone, speakers, input elements such as a keyboard or touch screen, etc.) as known in the art and as described herein with respect to FIG. 4. The fixtures 250 are configured to communicate with the elevator controller 215 as may be required to control dispatching operations for one or more elevator cars 203 associated with the elevator system 201. Although two elevator cars 203 are shown in FIG. 2A, those of skill in the art will appreciate that any number of elevators cars may be employed in the elevator and building systems that employ embodiments of the present disclosure. The elevator cars 203 can be located in the same hoistway or in different hoistways so as to allow coordination amongst elevator cars 203 in different elevator banks serving different floors (e.g., sky lobbies, etc.). It is understood that the elevator system 201 may include various features as described above with reference to FIG. 1 and may also include other non-depicted elements and/or features as known in the art (e.g., drive, counterweight, safeties, etc.). Moreover, the elevators may be employed in any configuration with all elevators serving all floors of the building, some elevators only serving certain floors, a first group of elevator serving lower floors of a building and a sky lobby and a second group of elevators serving the sky lobby and upper floors of the building, etc.

Also shown in FIG. 2 is a user device 231, such as a mobile device (e.g., smart phone, smart watch, wearable technology, laptop, tablet, etc.). The user device 231 may include a mobile and/or personal device that is typically carried by a person, such as a phone, PDA, etc. The user device 231 may include a processor, memory, and communication module(s), as shown in FIG. 4. The user device 231 may further include a user interface (e.g., a display screen, a microphone, speakers, input elements such as a keyboard or touch screen, etc.) as known in the art and as described herein with respect to FIG. 4. Finally, the elevator controller 215, may also include a processor, memory, and a communication module also as shown in FIG. 4. Similar to the user device 231, the elevator controller 215 may include processor, memory, and communication module implemented as described herein, but as part of the elevator system 201.

A user device e.g., 231, 331 and an elevator controller e.g., 115, 215, 315 and fixtures 250 in accordance with embodiments of the present disclosure can communicate with one another, e.g., as shown in FIG. 3. For example, one or more user device(s) 331, fixtures 350, and the elevator controller 315 may communicate with one another when proximate to one another (e.g., within a threshold distance). The user device 331, fixture 350, and the elevator controller 315 may communicate over a network 333, that may be wired or wireless. Wired communication can be conventional including standard hard wiring or Ethernet. Wireless communication networks can include, but are not limited to, Wi-Fi®, short-range radio (e.g., Bluetooth®), near-field infrared, cellular network, etc. In some embodiments, the elevator controller 315 may include, or be associated with (e.g., communicatively coupled to) one or more networked building elements 335, such as computers, fixtures 350, passenger interface or kiosks 350b, beacons, hall call fixtures 350, lanterns, bridges, routers, network nodes, etc. The networked building element 335 may also communicate directly or indirectly with the user devices 331 using one or more communication protocols or standards (e.g., through the network 333).

For example, the networked building element 335 may communicate with the user devices 331 using near-field communications (NFC) (e.g., network 333) and thus enable communication between the user devices 331 and the elevator controller 315. In some embodiments, the elevator controller 315 may establish communication with one or more user devices 331 that are outside of the structure/building. Such connection may be established with various technologies including GPS, triangulation, or signal strength detection, by way of non-limiting example. Such technologies that allow communication can provide users and the system(s) described herein more time to perform the described functions. In example embodiments, the user devices 331 communicate with the elevator controller 315 over multiple independent wired and/or wireless networks. Embodiments are intended to cover a wide variety of types of communication between the user devices 331 and the elevator controller 315, and embodiments are not limited to the examples provided in this disclosure.

The network 333 may be any type of known communication network including, but not limited to, a wide area network (WAN), a local area network (LAN), a global network (e.g. Internet), a virtual private network (VPN), a cloud network, and an intranet. The network 333 may be implemented using a wireless network or any kind of physical network implementation known in the art. In another embodiment, the network 333 is a daisy chained Ethernet network between the fixtures e.g., 350 and the elevator controller 315 as described further herein. The user devices 331 and/or the networked building element 335 may be coupled to the elevator controller 315 through multiple networks 333 (e.g., cellular and Internet) so that not all user devices 331 and/or the networked building element 335 are coupled to the elevator controller 315 through the same network 333. One or more of the user devices 331 and the elevator controller 315 may be connected to the network 333 in a wireless fashion. In one non-limiting embodiment, the network 333 is the Internet and one or more of the user devices 331 execute a user interface application (e.g. a web browser) to contact the elevator controller 315 through the network 333.

Embodiments provided herein are directed to apparatuses, systems, and methods for making and fulfilling requests for elevator service. In some embodiments, a request for elevator service may be communicated over one or more lines, connections, or networks, such as network 333, e.g., a request made by a user device 331 and transmitted through the network 333 to the elevator controller 315 to request elevator service. The request for service may be initiated by a mobile device controlled by and/or associated with a user, in a passive or active manner Other embodiments provided herein making and fulfilling requests for elevator service where the request for elevator service may be communicated over one or more lines, connections, or networks, such as network 333, e.g., a request made by fixture 350 and transmitted through the daisy chain Ethernet network (e.g., 333) as described herein to the elevator controller 315 to request elevator service. The request for service whether initiated by a mobile device controlled by and/or associated with a user, in a passive or active manner with a fixture 350. In some embodiments, the mobile device may be operative in conjunction with a Transmission Control Protocol (TCP) and/or a User Datagram Protocol (UDP). In some embodiments, a request for service may be authenticated or validated based on a location of the user device 331. In some embodiments, a request for service may be fulfilled in accordance with one or more profiles, such as one or more user or mobile device profiles. In some embodiments the profiles may be registered as part of a registration process. In some embodiments, an elevator system 101 may be registered with a service provider.

As noted, the elevator controller 315 may be associated with an elevator system (e.g., elevator systems 101, 201). The elevator controller 315 may be used to process or fulfill the requests for elevator service that are submitted from one or more user devices 331. The requests for elevator service may be received through the network 333 from the one or more user devices 331 and/or the networked building elements 335, which may be mobile devices, including, but not limited to phones, laptops, tablets, smartwatches, etc. One or more of the user devices 331 may be associated with (e.g., owned by) a particular user. The user may use his/her user device(s) 331 to request elevator service.

Referring now to FIG. 4, schematic block diagram illustrations of example computing systems 437 as may be employed for a user device 431, an elevator controller 415, or a kiosk or fixture 450 respectively, are shown. The computing system 437 may be representative of computing elements or components of user devices e.g., 331, 431, networked building elements 335, mobile devices controller, fixtures, etc. as employed in embodiments of the present disclosure. The computing system 437 can be configured to operate the user device 431, elevator controller 415, fixture, etc. including, but not limited to, operating and controlling a touch-screen display to display various output and receive various input from a user's interaction with the touch-screen display. The computing system 437 may be connected to various elements and components within a building that are associated with operation of an elevator system 101.

As shown, the computing system 437 includes a memory 439 which may store executable instructions and/or data. The executable instructions may be stored or organized in any manner and at any level of abstraction, such as in connection with one or more applications, apps, programs, processes, routines, procedures, methods, etc. As an example, at least a portion of the instructions are shown in FIG. 4 as being associated with a program 441. The memory 439 can include RAM and/or ROM and can store the program 441 thereon, wherein the program 441 may also include an operating system and/or applications to be used on the user device 431, elevator controller, fixtures 450 and the like. Further, the memory 439 may store data 443. The data 443 may include profile or registration data (e.g., in a user device 331, 431), a device identifier, or any other type(s) of data, product configuration and the like. The executable instructions stored in the memory 439 may be executed by one or more processors, such as a processor 445, which may be a mobile processor in the user device 431 mobile application or a standard processor as my be employed in the elevator controller 415, or a fixture 450. The processor 445 may be operative on the data 443 and/or configured to execute the program 441. In some embodiments, the executable instructions can be performed using a combination of the processor 445 and remote resources (e.g., data and/or programs stored in the cloud (e.g., remote servers)).

The processor 445 may be coupled to one or more input/output (I/O) devices 447. In some embodiments, the I/O device(s) 447 may include one or more of a physical keyboard or keypad, a touchscreen or touch panel, a display screen, a microphone, a speaker, a mouse, a button, e.g., parts or features of a telephone or mobile device (e.g., a smartphone). For example, the I/O device(s) 447 may be configured to provide an interface to allow a user to interact with the user device 431. In some embodiments, the I/O device(s) 447 may support a graphical user interface (GUI) and/or voice-to-text capabilities for the user device 431.

The components of the computing system 437 may be operably and/or communicably connected by one or more buses. The computing system 437 may further include other features or components as known in the art. For example, the computing system 437 may include one or more communication modules 449, e.g., transceivers and/or devices configured to receive information or data from sources external to the computing system 437. In one embodiment, the communication modules 449 of the user device 431 can include a near-field communication chip (e.g., Bluetooth®, Wi-Fi, etc.) and a cellular data chip, as known in the art. In some embodiments, the computing system 437 may be configured to receive information over a network (wired in some examples or wireless in others), such as network 333 shown in FIG. 3. The information received over the network may be stored in the memory 439 (e.g., as data 443) and/or may be processed and/or employed by one or more programs or applications (e.g., program 441).

The computing systems 437 may be used to execute or perform embodiments and/or processes described herein, such as within and/or on the elevator controller 415 and fixtures 450 to enable a user to make service requests to an elevator system. To make such service requests, the computing system 437 of fixture 450 may communicate with the computing system 437 of the elevator controller 415 as described herein.

Continuing now with FIGS. 2A and 2B, and the simplified illustration of an elevator system 201 employing a computing device 231 and fixtures 250 in accordance with an embodiment. The elevator controller 215 may be configured to control dispatching operations for one or more elevator cars e.g., 203 associated with the elevator system 201 as described herein. The fixtures 250, specifically the kiosk 250b include a touchscreen display and buttons to enable a user to enter a desired destination denoted as a destination request and then receive an acknowledgement from the elevator controller 215 of an assigned elevator car (e.g., 203). The fixtures 250, 250b may further include a user interface (e.g., a display screen, a microphone, speakers, input elements such as a keyboard or touch screen, etc.) as known in the art and described herein. The passenger may obtain information by viewing the touch screen 252, by hearing audible announcements through a speaker 254, or both. Controller 215 is configured to determine the intended destination of a passenger who utilizes the touch screen 252 in an appropriate manner.

FIG. 2A also depicts a dynamic display 260 for registered destination floors with respect to assigned cars at the lobby floor in accordance with an embodiment. In an embodiment, the display 260 is provided in the vicinity of the fixture 250, and more specifically fixture 250b where passenger would enter a destination request. The display is in operable communication with the elevator controller 215 and/or the fixture 250b as needed to have the elevator system 201 display various elevator system and destination dispatching information. For example in an embodiment, the display 260 is configured to be widely visible to arriving users and dynamically displays all assigned cars 203 with respect to currently assigned destination floors. If any existing car 203 is serving the desired floor, then passenger who has not entered any destination at the kiosk 250b can directly go to the designated car 203 and ride elevator without the need to enter a destination request. As a result, advantageously, if a passenger observes on the display 260, noting that the desired floor has already been assigned to a car 203, the destination entry is not needed and the time required to make the destination entry can be saved. Moreover, for a group of passengers or few passengers that are travelling to same destination floor, then each passenger need not stand in queue to register at the fixture 250b to enter their common destination request. In an embodiment, avoiding having to wait at the kiosk 250b can reduce passenger waiting times at the kiosk 250 and also may reduce waiting time of passengers in the lobby.

In addition, passengers requiring special assistance, instructions can be provided when any assistance up button 258 or assistance down button 259 pressed by passengers requiring special assistance simplifying their time at the kiosk 250b to make their request.

Passenger interface or kiosk 250b also includes an assistance up button 258 or assistance down button 259 that facilitates visually impaired, blind, or otherwise ability impaired passengers providing an indication of an intended destination. The assistance up button 258 or assistance down button 259 is also useful to assist passengers who may not be able to utilize the touch screen 252 for other reasons. The controller 215 determines when the assistance up button 258 or assistance down button 259 has been manipulated by a passenger and then subsequently manipulated by a passenger for purposes of determining the intended destination of that passenger. For purposes of discussion, manipulating the assistance up button 258 or assistance down button 259 includes pressing the buttons 258, 259, holding the buttons 258, 259, and releasing the buttons 258, 259, for example. The controller 215 is configured or programmed to recognize different kinds of manipulations of the assistance up button 258 or assistance down button 259, depending on the particular embodiment, several of which are described below. The assistance up button 258 or assistance down button 259 allows a passenger who cannot interact through the touch screen 252 to provide an indication of an intended destination to the elevator system 201 and to obtain information from the system through the speaker 254, the touchscreen display 252, or an information display 260 for example.

Prior elevator systems employed a single assistance button and various techniques for determining when a passenger had made their selection. For example, in one instance pressing and releasing the assistance button, and waiting as the potential destination floors are either announced on the speaker 254 or displayed on the display 252. The user then pressing and releasing the assistance button a second time to indicate the desired destination selection. Another example includes pressing and holding the assistance button as the display 252 on the kiosk 250b scrolled upward through various floor selections and the user then releasing when the desired floor was arrived at and displayed. In another instance, pressing and holding the assistance button as the system scrolled upward through various floor selection and releasing when the desired floor was announced by the speaker 254. In yet another instance repeatedly pressing and releasing the assistance button as the desired floor was displayed on the display 252 of the kiosk 250b and/or announced over the speaker 254. The potential target floor increments for each press and release of the assistance button. However, with each of these configurations, if the user did not press and/or release the assistance button at the appropriate time, or delayed in selecting a desired floor, the destination entry system would automatically increment to the next floor, and thereby causing the user to miss selecting the desired floor. Example of operation of the passenger interface and destination entry functions for passengers requiring special assistance may be found in U.S. Pat. No. 9,624,071 entitled Elevator Passenger Interface Including Special Assistance Features, issues Apr. 18, 2017 the entire contents of which are incorporated by reference herein.

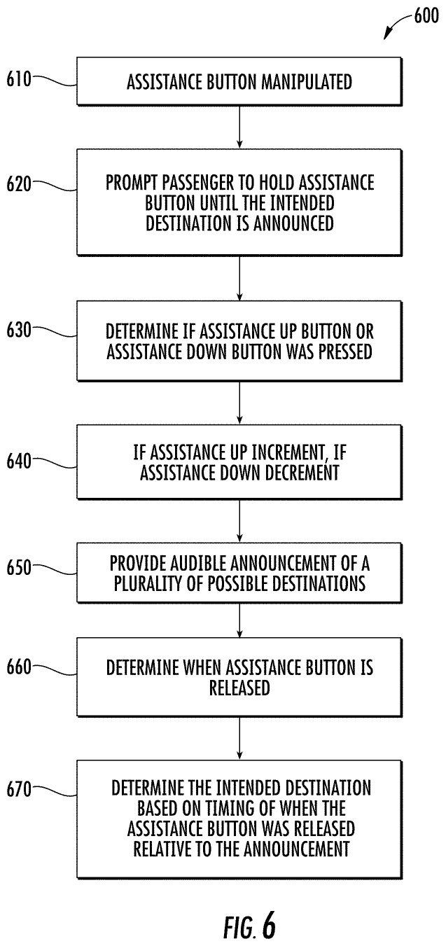

FIG. 5 includes a flowchart diagram that summarizes one example method 500 and technique for utilizing the up assistance button 258 and/or down assistance button 259 of a destination entry system in an elevator system 201. In an embodiment, a determination is made at 510 that the assistance up button 258 or assistance down button 259 has been manipulated. In this example, the initial manipulation comprises a passenger pressing the assistance up button 258 or assistance down button 259. Such manipulation is interpreted by the controller 215 based upon switch operation, for example. At process step 520, the passenger is prompted to press the assistance up button 258 or the assistance down button 259 when the intended destination is announced and/or depicted on the display 254. In one example, the controller 215 causes an audible announcement to be provided over the speaker 254 and a visual notice on the display such as, “Please press the accessibility button when your desired floor is announced.”

As shown at 530, an audible announcement of a plurality of possible destinations is provided over the speaker 254, while a visual depiction of the possible destinations is provided on the display 252. In one example, there is a several second delay between the end of one destination announcement and a beginning of the next destination announcement. The delay allows the passenger to press the assistance up button 258 or assistance down button 259 after hearing/seeing the intended destination before the next announcement.

Unfortunately, sometimes the passenger has difficulty responding quickly enough or fails to hear the plurality of destinations as they are announced, or fails to see them as they are provided on the display 252. As a result, the passenger may inadvertently miss identifying the desired destination floor in a timely manner In this instance, elevator controller 215 will continue incrementing until the last potential destination is announced before starting once again. In an embodiment, if the passenger presses the down assistance button 259 the elevator system 215 will now decrement the desired destinations permitting the user to select the destination that was inadvertently missed. At process step 540 the controller 215 determines when the assistance up button 258 or assistance down button 259 is pressed during the sequence of destination announcements, while at process step 550 the controller 215 determines if the assistance down button 259 was pressed, and if so changes direction and now provides an announcement of the plurality of possible destination but decrementing as depicted at process step 560. If the assistance up button 258 or the assistance down button 259 is pressed again as depicted at process step 570, the controller 215 accepts the presently announced possible destination. As a result, at 580 the controller 215 determines the intended destination based on the timing of when the assistance button was pressed relative to the announcement. In this example, the most recently announced destination prior to the assistance up button 258 or assistance down button 259 being pressed is determined to be the passenger's intended destination. It should be appreciated that while described with respect to the announced floors incrementing upward until the assistance down button 259 is pressed and then decrementing, in the alternative, the floors could decrement for as long as the assistance down button 259 is pressed or for as many times as the assistance down button 259 is pressed and then resume incrementing until the assistance up button 258 and/or assistance down button 259 is pressed to indicate the desired selection.

In one example, once the controller 215 determines the intended destination, an audible and/or confirmation and instructions are provided through the speaker 254 to the passenger to direct them to an appropriate elevator car. One example includes scheduling the assigned elevator car to remain at the landing where the passenger should board the car for an appropriate time that accommodates any extended walking time for the individual to arrive at the car and to board the car, for example.

In one example embodiment, while the controller 215 is sequentially providing an audible announcement of the possible destinations, the controller 215 determines whether the touch screen 252 has been touched. The controller 215 in such an example accepts contact with the touch screen 252 as a selection of the most recently announced destination. This accommodates the possibility that a passenger begins the assistance operation by manipulating the assistance up button 258 or assistance down button 259 and then subsequently utilizing the touch screen, perhaps inadvertently, for making the selection regarding the intended destination.

In one example, if the controller 215 begins the audible announcements and provides an indication of each possible destination without detecting any selection made by a passenger, the assistance operation times out and the controller returns to normal operation.

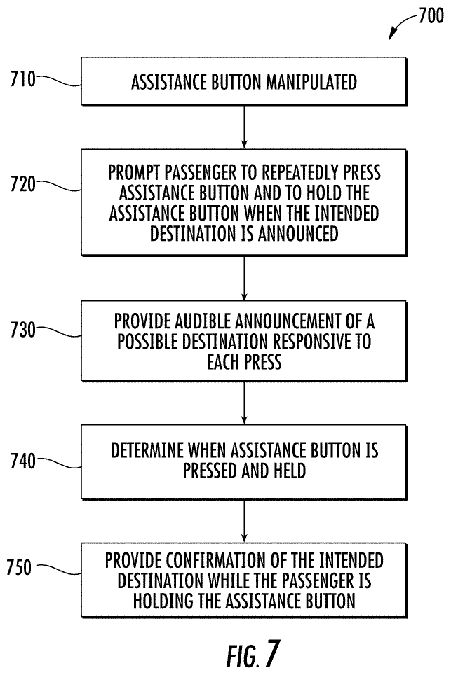

FIG. 6 includes a flowchart diagram 600 that summarizes another example technique. At 610 a determination is made that the assistance up button 258 has been manipulated. In this case, the manipulation comprises the button being either pressed and held or pressed and released. At 620 the passenger is prompted to hold the assistance up button 258 or assistance down button 259 in a pressed position until the intended destination of that passenger is announced. As depicted at 630, the controller determines if the assistance up button 258 or the assistance down button was pressed. If the passenger is holding the assistance up button 258, the controller 215 increments through the desired destinations, however, if the passenger is pressing the assistance down button 259, the controller 215 decrements through the possible desired destinations as depicted at process step 640. In this manner, the passenger can select the quickest and easiest way to arrive at a selection for the desired location. In the case of the passenger still holding the button, the passenger will be prompted to continue to do so until the intended destination is announced as depicted at process step 650. In a situation where the passenger has pressed and released the assistance up button 258, the passenger will be prompted to once again press the assistance up button 258 and hold it until the intended destination is announced.

At 650, the controller 215 causes audible announcements of a plurality of possible destinations to be provided over the speaker 254 or to be displayed on the display 252. One example includes a several second delay between the end of one destination announcement and the beginning of the next destination announcement. The passenger releases the assistance up button 258 or assistance down button 259 after one of the destination announcements that is determined to be the intended destination as shown at steps 660 and 670.

In one example, fixture 250 or the kiosk 250b provides an audible and visual confirmation of the determined intended destination and provides information to the passenger to allow them to reach the appropriate elevator car in situations in which the fixture 250 is a call button or kiosk 250b is located outside of an elevator car 103. For situations in which the fixture 250 is inside of an elevator car 103, the confirmation may simply provide an indication of the determined destination, or it may provide an indication of the amount of time the passenger should expect to wait until arriving at that destination.

FIG. 7 includes a flowchart diagram 700 summarizing another example technique. At 710 the determination is made that either assistance up button 258 or the assistance down button 259 has been manipulated. At 720, once again the passenger is prompted to repeatedly press the assistance up button 258 or assistance down button 259 and to hold the assistance button when the intended destination is announced or displayed. At 730 an audible announcement and visual display of a possible destination is provided responsive to each press of the assistance up button 258 or assistance down button 259. Once again the elevator controller 215 incrementing through the possible destinations if the assistance up button 258 is pressed and decrementing through the possible destination if the assistance down button 259 is pressed. In other words, the passenger is prompted to repeatedly press the assistance up button 258 or assistance down button 259 to sequentially change the possible destination until the passenger hears an audible announcement of the intended destination, and then to hold the button in a pressed position responsive to that announcement as shown.

At 740 the controller 215 determines when the assistance up button 258 or assistance down button 259 is pressed and held. Finally, at process step 750 a confirmation is provided to the passenger, which is audible or visual in this example, regarding the intended destination while the passenger is holding the assistance up button 258 or assistance down button 259. After hearing the confirmation of the intended destination, the passenger releases the assistance up button 258 or assistance down button 259 and proceeds to the appropriate elevator car 103 based on information provided from the passenger interface 20 (or simply remains on the car 103 in an embodiment in which the interface device 20 is within an elevator car 103).

Each of the examples mentioned above provides a different way of utilizing an assistance up button 258 or assistance down button 259 associated with a passenger interface device 20 that otherwise includes a touch screen 252 to allow passengers to obtain information regarding elevator service, and to provide an indication of requested elevator service. In each of those examples, the controller 215 causes audible announcements to be provided to assist a visually impaired or blind passenger with obtaining the desired elevator service.

In some situations, the number of floors to which the passenger could be carried is relatively large. Some examples include selecting a destination or floor at which to begin the announcements to shorten the time during which the passenger is waiting to hear an announcement of the intended destination.

In one example, the controller 215 begins the audible announcements using popular destinations. A determination regarding which destinations are popular may be gathered over time by the controller 215 by monitoring the number of selections of different destinations served by the elevator system 101. In another example, the controller 215 is preprogrammed to begin with preselected popular destinations.

One example includes using destinations that are popular based on a time of day. For example, during lunch time hours, the floor or floors on which a cafeteria or restaurant is located will be presented as the first options when the possible destinations are announced to a passenger who has manipulated the assistance up button 258 or assistance down button 259. In some examples, the announcement will indicate “cafeteria” instead of or in addition to the floor designation. Near the end of the day, a lobby or exit level of the building is a more popular destination and that will be presented as one of the first announcements at an appropriate time.

In another example, the controller 215 prompts the passenger to select a range of floors within which the passenger's intended destination is included. In a 40 story building, for example, the controller 215 may prompt the passenger to choose a range of floors 1-10, 11-20, 21-30 or 31-40 by providing an appropriate indication to the passenger that will allow them to make that selection. Once the appropriate range has been selected, the controller 215 begins to provide the announcement of possible destinations within that range. This allows a passenger to avoid having to hear audible announcements of floors 1-30 when the passenger desires to travel to floor 38, for example.

The examples described above allow for utilizing a touch screen display 252 for a passenger interface and facilitating interactions between a physically impaired, visually impaired or blind passenger and an elevator system so that all passengers can obtain elevator service even though a touch screen 252 is used as the primary input component to allow passengers to provide an indication of desired elevator service. Although visually impaired and blind passengers are mentioned in the above examples, passengers having other disability or impairments that would hinder them from successfully using the touch screen 252 but who can manipulate the assistance up button 258 or assistance down button 259 will be able to obtain the desired elevator service.

The above examples contain various features that are not necessarily exclusive to one particular embodiment. In other words, it is possible to combine features from the disclosed examples. The preceding description is exemplary rather than limiting in nature. Variations and modifications to the disclosed examples may become apparent to those skilled in the art that do not necessarily depart from the essence of the described embodiments. The scope of legal protection given to this invention can only be determined by studying the following claims.

As described above, embodiments can be in the form of processor implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the embodiments. When implemented on a general-purpose microprocessor, the computer program code segments configure the microprocessor to create specific logic circuits.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. Finally, the term “about” is intended to include the degree of error associated with measurement of the particular quantity and/or manufacturing tolerances based upon the equipment available at the time of filing the application.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of facilitating an elevator service request from at least one passenger, the method comprising:
determining a destination requested by a passenger responsive to a passenger touching an appropriate portion of a touch screen of a passenger interface device configured to allow a passenger to indicate a request for elevator service by touching the screen, an assistance up button and an assistance down button near the touch screen;
determining that the assistance up button or the assistance down button is being pressed; and
determining a destination requested by a passenger responsive to a passenger manipulating the assistance up button or the assistance down button and then subsequently manipulating the assistance up button and assistance down button.

2. The method of claim 1, further comprising:
determining if the assistance up button or the assistance down button has been pressed and released;
causing an audible announcement or visual display of a plurality of possible destinations to be provided to the passenger from the device; and
prompting the passenger to press the assistance up button or assistance down button a second time when the passenger hears an audible announcement or sees the visual display of the passenger's desired destination from the device;
determining the passenger's intended destination based on a timing that the assistance button is released relative to the audible announcement or visual display.

3. The method of claim 2, further comprising:
providing at least one of audible indication and visual display of possible destinations to the passenger responsive to determining that the assistance up button or the assistance down button has been pressed; and
providing at least one of an audible selection and a visual display to the passenger of a plurality of possible starting destinations from which to begin the at least one of audible indications and visual display.

4. The method of claim 1, further comprising:
prompting the passenger to hold the assistance up button or the assistance down button until the passenger hears an audible announcement or sees a visual display of the passenger's desired destination from the device;
causing an audible announcement or a visual display of a plurality of possible destinations to be provided to the passenger from the device; and
determining the passenger's intended destination based on a timing that the assistance up button or the assistance down button is released relative to the audible announcement or visual display.

5. The method of claim 4, further comprising:
providing at least one of audible indications and visual display of possible destinations to the passenger responsive to determining that the assistance up button or the assistance down button has been pressed; and
providing at least one of an audible selection and a visual display to the passenger of a plurality of possible starting destinations from which to begin the at least one of audible indications and visual display.

6. The method of claim 5, further comprising providing at least one of an audible indication and visual display of possible destinations to a passenger responsive to determining that the assistance up button or assistance down button has been pressed; and
beginning at least one of the audible indications and visual display with at least one destination that has been selected as a first option based on a popularity of the at least one destination and a time of day.

7. The method of claim 1, further comprising:
causing the device to provide an audible indication or a visual display of a possible destination responsive to each subsequent press of the assistance up button or the assistance down button;
prompting the passenger to press the assistance up button or assistance down button repeatedly until the passenger hears an announcement or sees the visual display of the passenger's intended destination and to hold the assistance up button or the assistance down button in a pressed position when the intended destination is announced or displayed until the passenger hears or sees a confirmation of the intended destination;
providing an audible confirmation or a visual display of a destination corresponding to the destination prior to the passenger holding the assistance up button or assistance down button in the pressed position; and
determining the passenger's intended destination to be the destination of the confirmation.

8. The method of claim 7, further comprising:
providing at least one of audible indications and visual display of possible destinations to the passenger responsive to determining that the assistance up button or the assistance down button has been pressed; and
providing at least one of an audible selection and a visual selection to the passenger of a plurality of possible starting destinations from which to begin the at least one of audible indications and visual display.

9. The method of claim 8, further comprising providing at least one of an audible indication and a visual display of possible destinations to a passenger responsive to determining that the assistance up button or assistance down button has been pressed; and
beginning the at least one of audible indications and visual display with at least one destination that has been selected as a first option based on a popularity of the at least one destination and a time of day.

10. An elevator passenger interface device, comprising:
a touch screen configured to allow a passenger to indicate a request for elevator service by touching the screen;
an assistance up button and an assistance down button disposed near the touch screen; and
a controller configured to:
determine a destination requested by a passenger touching the screen; and
determine whether the assistance up button or assistance down button has been manipulated and then to determine a destination requested by a passenger from a subsequent manipulation of the assistance up button or the assistance down button.

11. The elevator passenger interface of claim 10 further including the controller is configured to:
determine that the assistance up button or assistance down button has been pressed and released;
prompt the passenger to press and hold the assistance up button or assistance down button a second time until the passenger at least one of hears an audible announcement and sees a visual display of the passenger's desired destination from the device;
cause at least one of an audible announcement and a visual display of a plurality of possible destinations to be provided to the passenger from the device; and
determine the passenger's intended destination based on a timing that the assistance up button or assistance down button is released relative to the at least one of an audible announcement and a visual display.

12. The device of claim 11, wherein the controller is configured to determine the passenger's intended destination to correspond to the most recently announced destination or visual display prior to the when the passenger released the assistance up button or assistance down button.

13. The device of claim 11, wherein the controller is configured to:
provide at least one of an audible indication and a visual display of possible destinations to the passenger responsive to determining that the assistance up button or assistance down button has been pressed;
provide at least one of an audible selection and a visual selection to the passenger of a plurality of possible starting destinations from which to begin the at least one of audible indications and visual display.

14. The device of claim 11, wherein the controller is configured to provide at least one of an audible indication and a visual display of possible destinations to a passenger responsive to determining that the assistance up button and assistance down button has been pressed, wherein the at least one of an audible indication and a visual display begin with at least one destination that has been selected as a first option based on a popularity of the at least one destination and a time of day.

15. The elevator passenger interface of claim 10 further including the controller is configured to:
determine that the assistance up button or assistance down button is being pressed;
prompt the passenger to hold the assistance up button or assistance down button until the passenger at least one of hears an audible announcement and sees a visual display of the passenger's desired destination from the device;
cause at least one of an audible announcement and a visual display of a plurality of possible destinations to be provided to the passenger from the device; and
determine the passenger's intended destination based on a timing that the assistance up button or assistance down button is released relative to the at least one of the audible announcement and the visual display.

16. The device of claim 15, wherein the controller is configured to determine the passenger's intended destination to correspond to the most recently announced destination prior to the when the passenger released the assistance up button or assistance down button.

17. The device of claim 15, wherein the controller is further configured to:
provide at least one of an audible indication and a visual display of possible destinations to the passenger responsive to determining that the assistance up button or assistance down button has been pressed; and
provide at least one of an audible selection and a visual display to the passenger of a plurality of possible starting destinations from which to begin the at least one of audible indications and visual display.

18. The device of claim 15, wherein the controller is configured to provide at least one of an audible indication and a visual display of possible destinations to a passenger responsive to determining that the assistance up button or assistance down button having been pressed, wherein at least one of the audible indications and the visual display begin with at least one destination that has been selected as a first option based on a popularity of the at least one destination and a time of day.

19. The elevator passenger interface of claim 10 further including the controller is configured to:
determine that the assistance up button or assistance down button has been pressed;
cause the device to provide at least one of an audible indication and a visual display of a possible destination responsive to each subsequent press of the assistance up button or assistance down button;
prompt the passenger to press the assistance up button or assistance down button repeatedly until the passenger at least one of hears an announcement and sees a visual display of the passenger's intended destination and to hold the assistance up button or assistance down button in a pressed position when the intended destination is announced or displayed until the passenger hears a confirmation of the intended destination;
provide at least one of an audible confirmation and a visual display of a destination corresponding to at least one of an announced and displayed destination prior to the passenger holding the assistance up button or assistance down button in the pressed position; and
determine the passenger's intended destination to be the destination of the confirmation.

20. The device of claim 19, wherein the controller is configured to:
provide at least one of an audible indication and a visual display of possible destinations to the passenger responsive to determining that the assistance up button or assistance down button has been pressed; and
provide at least one of an audible selection and a visual display to the passenger of a plurality of possible starting destinations from which to begin the at least one of an audible indication and a visual display.

21. The device of claim 19, wherein the controller is configured to provide an at least one of an audible indication and a visual display of possible destinations to a passenger responsive to determining that the assistance up button or assistance down button has been pressed, wherein the at least one of an audible indication and a visual display begin with at least one destination that has been selected as a first option based on a popularity of the at least one destination.
